(19) United States
(12) Patent Application Publication
(10) Pub. No.: US 2014/0049385 A1
(43) Pub. Date: Feb. 20, 2014

(54) METHOD FOR SENDING AN ELECTRONIC DISTRESS CALL

(71) Applicant: GM GLOBAL TECHNOLOGY OPERATIONS LLC, Detroit, MI (US)

(72) Inventor: Timo MUELLER, Limburg (DE)

(73) Assignee: GM GLOBAL TECHNOLOGY OPERATIONS LLC, Detroit, MI (US)

(21) Appl. No.: 13/968,538

(22) Filed: Aug. 16, 2013

(30) Foreign Application Priority Data
Aug. 16, 2012 (DE) 10 2012 016 241.3

(51) Int. Cl. B60Q 9/00

(52) U.S. Cl. CPC B60Q 9/00
USPC 340/436

(57) ABSTRACT

A method is provided for sending an electronic distress call from a motor vehicle involved in an accident, in which the distress call can be sent by utilizing short-range radio data transmission and received by conventional mobile terminals in the vicinity of the accident site. The electronic distress call is triggered with an acceleration signal and/or with the activation signal of a safety system. An apparatus and a control unit are provided for sending a distress call from a vehicle involved in an accident.

### CROSS-REFERENCE TO RELATED APPLICATION

This application claims priority to Patent Application No. 10 2012 016 241.3, filed Aug. 16, 2012, which is incorporated herein by reference in its entirety.

### TECHNICAL FIELD

The technical field relates to the technical field of passenger safety in motor vehicles and, in particular, to a method for sending an electronic distress call from a motor vehicle involved in an accident.

### BACKGROUND

Fast aid is of decisive importance when a motor vehicle has an accident. Many people are unaware that corresponding first-aid instructions and rescue data sheets are available on the Internet and where they could be found. A website for rescue data sheets has already been established for emergency service personnel, but an Internet connection is absolutely imperative in order to retrieve these data sheets. This is the reason why motor vehicles will in the future automatically send out an eCall (emergency-Call). German utility model DE 20 2009 003 971 U1 discloses an apparatus for assisting first responders, particularly for the storage and on-demand playback of an acoustical and/or optical signal. The apparatus is detachably arranged on a portable first-aid unit.

At least one objective is solving the aforementioned problems and of improving passenger safety after an accident in a simple and reliable fashion. In addition, other objectives, desirable features and characteristics will become apparent from the subsequent summary and detailed description, and the appended claims, taken in conjunction with the accompanying drawings and this background.

### SUMMARY

According to one embodiment, a method is provided for sending an electronic distress call from a motor vehicle involved in an accident. The distress call is sent by utilizing short-range radio data transmission and received by conventional mobile terminals in the vicinity of the accident site. The motor vehicle therefore delivers important rescue information to terminals of persons who are already at the accident site such as, e.g., first-aid instructions for passersby. It can also make available information such as, e.g., vehicle data or vehicle construction on terminals of the fire department arriving at the accident site. In this respect, the mobile terminals may consist, e.g., of telephones, laptops or tablet PCs and similar devices that are carried along by persons in the vicinity of the accident site. Corresponding terminals may also be installed in a motor vehicle that is located in the vicinity of the accident site. The short-range radio data transmission therefore may be realized differently depending on which type of terminals should be addressed. Consequently, it would be conceivable to utilize anything from IR (infrared) to RFID (Radio Frequency Identification) and NFC (Near Field Communication) and even ZigBee technologies, such as Bluetooth or in the broadest sense also WLAN (Wireless Local Area Networks).

The electronic distress call is triggered with an acceleration signal. In this context, acceleration refers to a positive acceleration, as well as a negative acceleration. The corresponding signal is triggered if a critical acceleration value is exceeded or not reached. This usually makes it possible to reliably detect an accident scenario. The electronic distress call may alternatively or additionally also be triggered with an activation signal of a safety system. This not only allows a reliable, but also a particularly simple detection of an accident scenario because the acceleration state has already been reliably evaluated once this signal is generated.

In any case, it is possible to render faster, more purposeful and more competent aid to the passengers of a motor vehicle involved in an accident such that lives can be saved and/or the consequences of an accident can be moderated. An Internet connection is, in principle, no longer required in this case because network technology is available everywhere.

According to another embodiment, it is proposed that a Bluetooth radio signal is generated in order to send the electronic distress call because an increasing number of motor vehicles are equipped with Bluetooth technology. According to another embodiment, first-aid instructions and/or vehicle information and/or passenger information is/are included in the distress call. In this case, the first-aid instructions may comprise, e.g., at least a list of all available resources in a motor vehicle first-aid kit according to DIN 13164 and the vehicle information may comprise, e.g., at least the contents of manufacturer-specific rescue data sheets. The passenger information may comprise, e.g., information on the number of passengers that was obtained from the seat occupancy detection system. However, it is also possible to provide driver-specific information because future vehicles may also be personalized to the respective driver, i.e., store data of the driver. In this way, first and second responders can obtain information on the general state of health and the blood type of the driver, as well as on any medication taken by the driver.

According to another embodiment, it is proposed that a link-up request to a mobile terminal is included in the electronic distress call. In this way, the motor vehicle proactively searches, e.g., for mobile telephones in the vicinity of the accident site and offers the option of retrieving first-aid instructions. The described method, as well as the advantageous embodiments, may be implemented in a safety system of the motor vehicle, particularly in its control unit.

The control unit may feature a digital microprocessor unit (CPU) that is data-linked to a storage system and a bus system, a random-access memory (RAM) and a storage means. The CPU is designed for processing commands that are realized in the form of a program stored in a storage system, for acquiring input signals from the data bus and for delivering output signals to the data bus. The storage system may feature different storage mediums such as optical, magnetic, solid-state and other non-volatile mediums, on which a corresponding computer program for carrying out the method, as well as the advantageous embodiments, is stored. The program may be realized in such a way that it respectively embodies or is capable of carrying out the described methods in order to enable the CPU to carry out the steps of such methods and therefore to send a distress call from a motor vehicle involved in an accident.

A suitable computer program for carrying out the inventive method features program code means for carrying out all steps disclosed in any of the claims when the program is executed on a computer. The computer program can be loaded on and used in already existing control units with simple means in order to control an apparatus for sending an electronic distress call from a motor vehicle involved in an accident.

To this end, the invention proposes a computer program product with program code means that are stored on a machine-readable data carrier in order to carry out the method according to any of the claims when the program product is executed on a computer. The computer program product may also be integrated into control units in the form of a retrofitting option.

An apparatus for sending an electronic distress call from a motor vehicle involved in an accident, which embodies the advantages of the above-described method, is elucidated below. One embodiment of the invention concerns an apparatus for sending an electronic distress call from a motor vehicle involved in an accident that comprises means for sending the distress call by utilizing short-range radio data transmission such that the distress call can be received by conventional mobile terminals in the vicinity of the accident site. The motor vehicle can then easily and reliably make available helpful information on accidents to persons who are already in the vicinity of the accident site without the presence of an Internet connection.

In this case, the apparatus comprises means for triggering the electronic distress call with an acceleration signal such that a particularly reliable detection of an accident is ensured. The apparatus may alternatively or additionally also comprise means for triggering the electronic distress call with the activation signal of a safety system that allows a particularly simple detection of an accident. Consequently, it is possible to render fast, purposeful and competent help such that lives can be saved and/or the consequences of an accident can be moderated.

Another embodiment of the apparatus comprises means for generating a Bluetooth radio signal in order to send the electronic distress call. Such a means frequently is already installed in modern motor vehicles and therefore can be easily utilized. Another embodiment of the apparatus comprises means for including first-aid instructions and/or vehicle information and/or passenger information in the electronic distress call. Consequently, extensive information is made available to persons near the accident site (first-aid instructions), as well as fire departments (vehicle information) and emergency medical services (passenger information). Another embodiment of the apparatus comprises means for including a link-up request to a mobile terminal in the electronic distress call. In this way, a proactive search for suitable terminals can be realized in the vicinity of the motor vehicle involved in an accident.

### BRIEF DESCRIPTION OF THE DRAWINGS

The present invention will hereinafter be described in conjunction with the following drawing figures, wherein like numerals denote like elements, and:

FIG. 1 shows a block diagram of an embodiment of the method;

FIG. 2 shows a vehicle with an embodiment of the apparatus; and

FIG. 3 shows a control unit for carrying out the embodiment of the.

### DETAILED DESCRIPTION

The following detailed description is merely exemplary in nature and is not intended to limit application and uses. Furthermore, there is no intention to be bound by any theory presented in the preceding background or summary or the following detailed description.

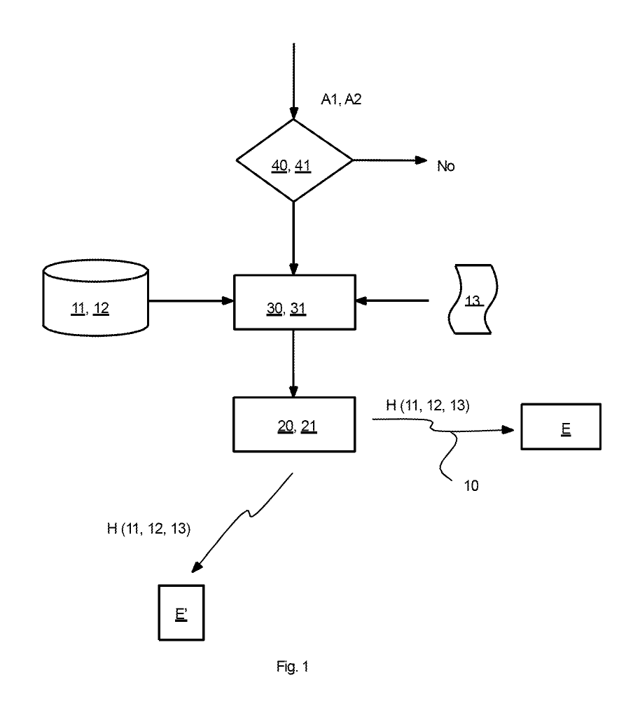

FIG. 1 shows a block diagram of a method including the apparatus used in this method. If a motor vehicle is involved in an accident, an acceleration signal A1 and/or an activation signal A2 for a safety system such as, e.g., an airbag system or a passenger restraint system is generated and a distress call H is sent to mobile terminals in the vicinity of the accident site of the basis of a Bluetooth radio signal 10 in this case. First-aid instructions 11 and/or vehicle information 12 and/or passenger information 13 are included in the distress call H.

After an accident that is registered by triggering the airbag or the acceleration sensors similar to an eCall, Bluetooth therefore is automatically activated and offers connections to mobile terminals E, E′. Consequently, passersby in the vicinity can utilize their smartphone in order to connect to the motor vehicle and to automatically receive first-aid instructions. It would also be conceivable that the motor vehicle actively searches for mobile telephones in the vicinity and proactively offers the connections. In this case, a passerby receives a link-up request and subsequently first-aid instructions.

As the fire department approaches the accident site, the firemen can connect to the motor vehicle with their Bluetooth devices such as a telephone, a tablet PC or a laptop and obtain useful information such as, e.g., rescue data sheets without requiring an Internet connection. These rescue data sheets comprise vehicle-specific information such as, e.g., where the battery is located, how the wiring system is structured and how to render the motor vehicle current less, where to attach cutting devices in order to cut the door frame and rescue passengers, etc. It is furthermore possible to provide telemetry data of the motor vehicle such as, e.g., if the fuel line was already closed or if the doors were opened. In the near future, it should also be possible to provide driver data in motor vehicles that are personalized to a specific driver. In this way, first and second responders can obtain information on the general state of health and the blood type of the driver, as well as on any medication taken by the driver, via the same system.

The apparatus for sending the distress call 10 comprises a device 20 for generating the distress call that in this case specifically features a device 21 for sending a Bluetooth radio signal 10. The information content of the distress call H is defined by a device 30 for including first-aid instructions 11 and/or vehicle information 12 and/or passenger information 13 and by a device 31 for including a link-up request 13. The device 20, 21, 30 and 31 should not be activated until a device 40 for triggering the electronic distress call H receives the acceleration signal A1 and/or a device 41 for triggering the electronic distress call H receives the activation signal A2 of a safety system. If the acceleration signal A1 does not meet the predefined criteria for triggering the method for sending the distress call H without the activation signal A2 of the safety system, the devices 20 . . . 31 are not activated and no distress call H is sent as indicated by the branch NO (No Operation) of the process sequence toward the right on the means 40, 41.

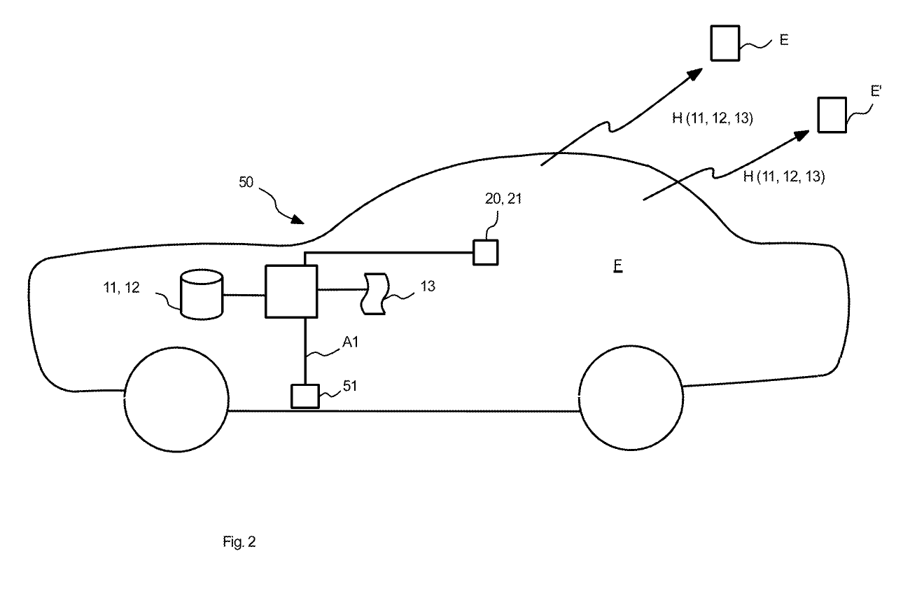

FIG. 2 shows a motor vehicle F with an apparatus 50 that may consist, e.g., of an airbag control unit and into which the devices 30 . . . 41 are integrated in a housing. An acceleration signal A1 is made available by an acceleration sensor 51. If the value of this acceleration signal lies above a critical value, it is assumed that an accident has occurred and a distress call H that includes first-aid instructions 11 and/or vehicle information 12 and/or a link-up request 13 is generated. This distress call H is transmitted by the respective device 20, 21 for generating a distress call H and for sending a Bluetooth radio signal and can be received by terminals E, E′ in the vicinity of the motor vehicle.

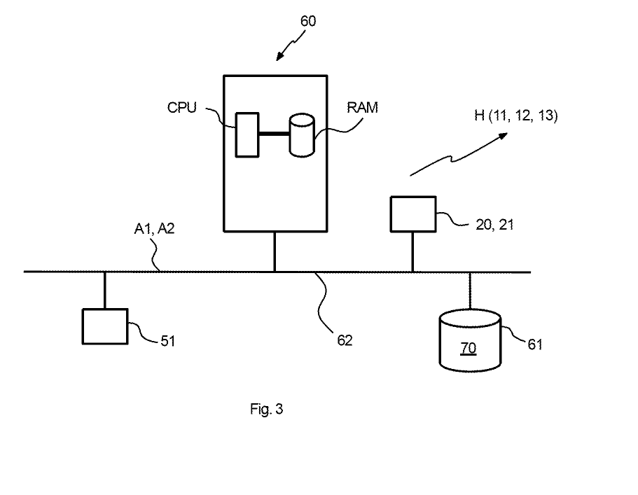

FIG. 3 shows a control unit 60 for carrying out the method that may be realized, e.g., in the apparatus 50 according to FIG. 2 and comprises a CPU and a random-access memory RAM. The CPU is designed for processing commands that are realized in the form of a program 70 stored in a storage system 61, for acquiring input signals from the data bus 62 and for delivering output signals to the data bus 62. The acceleration signal A1 of the acceleration sensor 51 and/or the activation signal A2 of a safety system should in this case be applied to the data bus 62 and the distress call H should be sent by respective means 20, 21 for generating a distress call H and for sending a Bluetooth radio signal that in a manner of speaking are linked via the data bus 62.

The storage system 61 may feature different storage mediums such as optical, magnetic, solid-state and other non-volatile mediums, on which a corresponding computer program 70 for carrying out the method, as well as the advantageous embodiments, is stored. The program 70 may be realized in such a way that it respectively embodies or is capable of carrying out the described methods in order to enable the CPU to carry out the steps of such methods and therefore to send a distress call H from a motor vehicle F involved in an accident.

A suitable computer program 70 for carrying out the method features program code for carrying out all steps disclosed in any of the claims when the program 70 is executed on a computer. The computer program 70 can be loaded on and used in already existing control units with simple devices in order to control an apparatus for sending an electronic distress call from a motor vehicle involved in an accident. To this end, a computer program product with program code that is stored on a machine-readable data carrier is proposed in order to carry out the method according to any of the claims when the program product is executed on a computer. The computer program product may also be integrated into control units in the form of a retrofitting option.

All in all, this results in a method and an apparatus that increase the passenger safety after an accident of a motor vehicle in a simple and reliable fashion.

Although a few potential embodiments of the invention were disclosed in the preceding description, it goes without saying that numerous other variations of embodiments can be realized with optional combinations of all described technical characteristics and embodiments and furthermore all technical characteristics and embodiments obvious to a person skilled in the art. It furthermore goes without saying that the exemplary embodiments should merely be interpreted as examples that do not limit the scope of validity, the applicability and the configuration in any way. In fact, the preceding description is intended to provide a person skilled in the art with a suitable plan for implementing at least one exemplary embodiment. It also goes without saying that the function and the arrangement of elements described with reference to an exemplary embodiment can be changed in numerous ways without deviating from the scope of validity of the attached claims and their legal equivalents.

1. A method for sending an electronic distress call from a motor vehicle involved in an accident, comprising:
triggering the electronic distress call with an activation signal of a safety system;
receiving the electronic distress call with mobile terminals in a vicinity of an accident site and
transmitting the electronic distress call with a short-range radio data transmission, is triggered with the activation signal.

2. The method according to claim 1, further comprising generating a Bluetooth radio signal to send the electronic distress call.

3. -The method according to claim 1, further comprising inserting first-aid instructions in the electronic distress call.

4. The method according to one claim 1, further comprising inserting a link-up request to a mobile terminal is in the electronic distress call.

5. (canceled)

6. (canceled)

7. An apparatus for sending an electronic distress call from a motor vehicle involved in an accident, comprising,
a short-range radio that is configured to send the distress call by utilizing short-range radio data transmission such that the electronic distress call is received by conventional mobile terminals in a vicinity of an accident site;
a triggering device that is configured to trigger the electronic distress call with with an activation signal of a safety system.

8. The apparatus according to claim 7, further comprising a Bluetooth device that is configured to generate a Bluetooth radio signal in order to send the electronic distress call.

9. The apparatus according to claim 7, further comprising an insertion device that is configured to insert first-aid instructions in the electronic distress call.

10. The apparatus according to claim 7, further comprising an uplink device that is configured to include a link-up request to a mobile terminal in the electronic distress call.

11. The method according to claim 1, further comprising inserting first-aid instructions for sending the electronic distress call from the motor vehicle involved in the accident

12. The method according to claim 1, wherein the activation signal is an acceleration signal

13. The method according to claim 1, further comprising inserting vehicle information in the electronic distress call.

14. The method according to claim 1, further comprising inserting passenger information in the electronic distress call

15. The apparatus according to claim 7, wherein the activation signal is an acceleration signal.

16. The method according to claim 1, further comprising inserting vehicle information in the electronic distress call.

17. The method according to claim 1, further comprising inserting and/or passenger information

18. A non-transitory computer readable medium embodying a computer program product, said computer program product comprising:
a program for sending an electronic distress call from a motor vehicle involved in an accident, the program configured to:
trigger the electronic distress call with an activation signal of a safety system;
receive the electronic distress call with mobile terminals in a vicinity of the accident site; and
transmit the electronic distress call with a short-range radio data transmission.

19. The non-transitory computer readable medium according to claim 18, the program further configured to generate a Bluetooth radio signal to send the electronic distress call.

20. The non-transitory computer readable medium according to claim 18, the program further configured to insert first-aid instructions in the electronic distress call.

21. The non-transitory computer readable medium according to claim 18, the program further configured to insert a link-up request to a mobile terminal in the electronic distress call.
